(19) United States
(12) Patent Application Publication
(10) Pub. No.: US 2020/0234230 A1
(43) Pub. Date: Jul. 23, 2020

(54) PHOTO-BASED INVENTORY SYSTEM AND METHOD OF USE

(71) Applicants: Blaine Hilton, Arlington, TX (US); Alfonso Lerma, Arlington, TX (US)

(72) Inventors: Blaine Hilton, Arlington, TX (US); Alfonso Lerma, Arlington, TX (US)

(21) Appl. No.: 16/747,300

(22) Filed: Jan. 20, 2020

Related U.S. Application Data
(60) Provisional application No. 62/794,685, filed on Jan. 20, 2019.

(51) Int. Cl. G06Q 10/08; G06K 9/00

(52) U.S. Cl. CPC G06Q 10/087; G06K 9/00671; G06K 9/00201

(57) ABSTRACT

A photo-based inventory system includes a computing device with a camera, an inventory management platform accessible via the computing device, a plurality of inventory products, a plurality of images and videos associated with the inventory products, and an inventory log. The inventory management platform captures information about each of the inventory products based on the images and videos captured and stores the information in the inventory log.

### BACKGROUND

### 1. Field of the Invention

The present invention relates generally to an inventory system and methods of use. More specifically, the invention is related to a system and method to perform an inventory audit by allowing a user to take photographs of inventory items in a system that will enable a logic path to determine the item or product identity and quantity of that item present.

### 2. Description of Related Art

Inventory systems and methods of use are well known in the art. Typically a person will use pen and paper, perhaps starting from a printed text file of what was found from the last inventory audit and manually walk through a facility making note of what items are still there, what had been added and what items have been removed, sold, or disposed of. The person performing the audit may also use a variety of software and mobile app devices in the same fashion wherein a digital inventory list is kept and maintained as stored on an electronic device or in the cloud.

Some software also has the capability to allow a person to scan for UPC barcodes and allow that as part of an association of information. For example, when a person is looking at an item, he or she is typically looking for the following pieces of information: manufacturer name, product name, product code, and container size. These information tags could then be identified via the UPC barcode and automatically updated into the digital inventory log. Some software has the capacity to scan for other types of 1D or 2D codes or other types of product identifiers such as a QR code or other data scannable code. The code may be an image, barcode, or other scannable identifier.

One of the problems commonly associated with the above process is the limited use. Sometimes, the UPC barcode is not available or the packaging upon which the UPC barcode is damaged and thus unreadable. In many cases, not all products or packaging of particular items even feature UPC barcodes. In other circumstances, a person must carefully scan the UPC barcode, manually picking up each item to register it. The auditor must also have the accompanying compatible software that knows how to populate a digital inventory log to make scanning the UPC barcode a viable method of data entry.

Although great strides have been made in the area of inventory systems and methods of use, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a photo-based inventory system in accordance with a preferred embodiment of the present application; and

FIG. 2 is a flowchart of a method of use of the photo-based inventory system.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional systems and methods for inventory systems. Specifically, the present invention is directed an inventory application that uses pictures and images to enable a logic path to determine the item or product identity and quantity present in the inventory. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

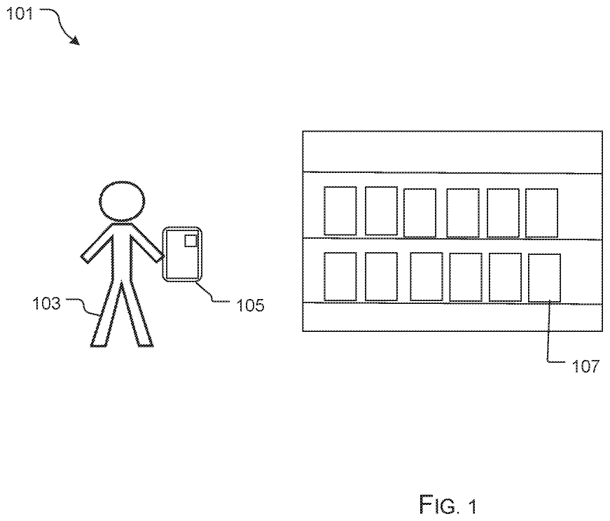

Referring now to the drawings wherein like reference characters identify corresponding or similar elements throughout the several views, FIG. 1 depicts a simplified schematic of the present invention in accordance with a preferred embodiment of the present application. It will be appreciated that system 101 overcomes one or more of the above-listed problems commonly associated with the conventional inventory systems.

The present invention is a system 101 wherein a user 103 simply takes photographs of the products 107 in the inventory with an electronic device 105 having an accessible camera and capability to store and transmit photographs taken by the camera. No manual data entry by hand or by digital input is required, even if the product 107 has not already been associated with the product information that usually is required to be typed in. From a process perspective, all of the most time-consuming parts of inventory audits is left to the application to take the captured photos and produce a deliverable work product of an accessible, transmittable and storable file type.

In a further embodiment, the inventory application may be configured to allow the deliverable work product 107 to be integrated with a safety data sheet (SDS) management system. This system may be either a web-based system, or software installed on a computer, or a mobile app on a smartphone, or a client/server application or other embodiment.

An alternate embodiment of the present invention may include the capability for a user 103 to take a photograph of multiple products 107 at once with the application being able to recognize individual products 107. A further embodiment may include the capability for a user 103 to take a video of a series of products wherein the application may process the video and determine, through a specified logic path, the quantity and other necessary item information for each item depicted in the video. This is especially beneficial for audits of high-density products such as those kept inside a flammable cabinet and wherein a user 103 does not have to locate the UPC barcode or other data scannable code of the product for the application to be able to use its logic code to determine the necessary item information. This is additionally beneficial for audits of products or items on a retail environment shelf, display, storage cabinet or other location wherein inventory items or products may be stored.

The logic code includes steps to be able to determine from a photo or video information about the products 107 including, but not limited to, the label, the brand, the product number, the manufacturer, the date of manufacturing, the date of packaging, the date of deliver, the quantity of the item, the container size, the shelf life of the product, a combination thereof or other relevant details.

It is anticipated that the inventory application may be housed in any electronic device 105 including but not limited smartphones, tablets, laptops and desktops. The application may be configured to access images stored on the electronic device 105 or have the ability to directly access a camera integrated into the electronic device 105 and store images captured by the camera in the application. Additionally, the application may be configured to be able to send the captured images to be stored in a cloud or web-based storage platform. Once the application has accessed an image for processing, a logic path is enabled to identify the label of the product and any other relevant information. The application then integrates the identified information into a deliverable work product of either a spreadsheet or other file type that is compatible with SDS management software or application. Additionally, the file type may be compatible with other software such as Microsoft Office that the user 103 may download onto electronic device 105 such as computers.

Referring now to FIG. 1, a simplified schematic of the present invention is shown wherein a user 103 holds an electronic device 105 having a camera to take a picture or video of items 107 needing to be inventoried, wherein an application housed on the electronic device 105 processes the image or video, determines through a logic path the product identity and quantity in the inventory, and creates a log or file of the items that have been identified and quantified.

It is contemplated that the images captured by the camera may be sent to a general server wherein the application is housed, such that the processing of the image is done at the general server and wherein the product identity and quantity, a log of the items or a combination thereof, in the inventory is transmitted to a user's 103 electronic device 105 for further analysis or use.

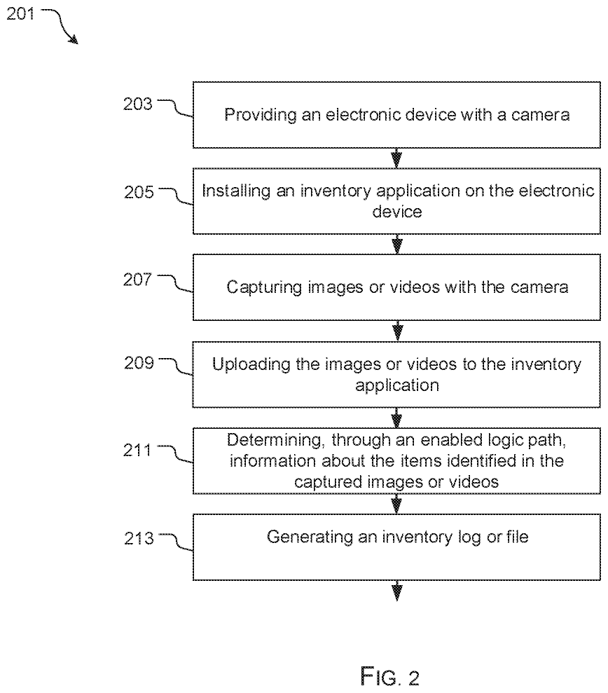

Referring to FIG. 2, a flowchart of the preferred method of use of the present invention, the method comprising: providing an electronic device having a camera, the electronic device being able to store images captured by the camera 203; installing a photo-based inventory application onto the electronic device 205; capturing a series of images or videos showing multiple inventory items 207; uploading the images or videos to the application 209; determining, through a logic path, item information including quantity and product name 211; and producing a downloadable and editable deliverable work product or file delineating the inventory items and information that was identified by the application 213.

It is anticipated that the inventory application may be configured as a mobile application, a web-based application or as a software. The inventory application may be in communication with a centralized server housing a processor and a storage device, wherein several electronic devices 105 having the inventory application may access the centralized server and accompanying processor and storage device. The storage device in the server may be configured to store the images captured by an electronic device 105 and the generated inventory file or spreadsheet. Alternatively, the images and the generated inventory files may be stored locally on the electronic device 105 or other personal storage device. Additionally, the logic path enabled when the application accesses an image may be stored and executed in the application locally on a user's 103 electronic device 105 or may be stored and executed in the centralized server.

It is contemplated that the inventory application and its preferred method of use may be adapted to any industry or inventory type. It is anticipated that the items to be inventoried may be of any product type including but not limited to chemical products, industrial supplies and materials, food items, clothing items, equipment, or other item typically found in an inventory, whether that inventory is personally or commercially owned or managed.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A photo-based inventory system, comprising:
a computing device having a camera;
an inventory management platform accessible via the computing device;
a plurality of inventory products;
a plurality of images wherein each image of the plurality of images is associated with an inventory product of the plurality of inventory products;
a plurality of videos wherein each video of the plurality of videos is associated with an inventory product of the plurality of inventory products;
an inventory log created by the inventory management platform based on the plurality of inventory products; and
wherein the inventory management platform uses the plurality of images and the plurality of videos to identify information about each inventory product of the plurality of inventory products.

2. The photo-based inventory system of claim 1, wherein the inventory log is a digital file.

3. The photo-based inventory system of claim 1, wherein one or more safety date sheets (SDS) are integrated into the inventory management platform and associated with one or more of the plurality of inventory products.

4. The photo-based inventory system of claim 1, wherein the inventory management platform is an Internet application.

5. The photo-based inventory system of claim 1, wherein the inventory management platform is an application installed on a mobile computing device.

6. A method of photo-based inventory management, the method comprising:
providing a computing device with a camera;
installing a photo-based inventory management platform on the computing device;
capturing a plurality of images and a plurality videos with the camera;
uploading the plurality of images and the plurality of videos to the photo-based inventory management platform;
determining, through an enabled logic path, information about one or more items identified in the plurality of images and the plurality of videos; and
generating an inventory log as a digital file.
